(19) United States
(12) Patent Application Publication
(10) Pub. No.: US 2026/0262871 A1
(43) Pub. Date: Sep. 10, 2026

(54) DEVICE AND METHOD FOR PRODUCING MILK-AIR EMULSIONS

(71) Applicant: Melitta Professional Coffee Solutions GmbH & Co. KG, Minden (DE)

(72) Inventors: Thomas DIESTER, Bückeburg (DE); Bernd BUCHHOLZ, Rahden (DE); Patrick WILKE, Bückeburg (DE)

(73) Assignee: Melitta Professional Coffee Solutions GmbH & Co. KG, Minden (DE)

(21) Appl. No.: 19/489,300

(22) PCT Filed: Jul. 17, 2024
(86) PCT No.: PCT/EP2024/070330

§ 371 Date: Dec. 2, 2025

(30) Foreign Application Priority Data
Jul. 27, 2023 (DE) 10 2023 119 916.1
Feb. 22, 2024 (DE) 10 2024 105 055.1

(51) Int. Cl. A47J 31/44; A47J 31/52

(52) U.S. Cl. CPC A47J 31/4489; A47J 31/52

(57) ABSTRACT

An apparatus for producing a milk-air emulsion has at least one steam lance which is designed to be dipped into a vessel filled with milk. With the aid of a steam system and with the aid of an air system, steam and air can be conducted through the steam lance into the milk. The steam system and the air system can each be controlled by means of a control device on which a milk-air-emulsion production program is loaded and can be executed, the control device having access to a memory on which at least one or more milk/air emulsion production profiles is/are stored such that the steam and the air can be conducted into the milk in accordance with a selected milk/air emulsion production profile in each case, in order to produce the milk/air emulsion automatically in the vessel.

The invention relates to a device and a method for producing a milk-air emulsion, preferably milk foam.

It is known that a milk-air emulsion, in particular milk foam, can be produced in a container such as a pitcher filled with milk using a steam lance, which may have a steam line and an air line. To do this, the person preparing the coffee with a coffee machine usually holds the pitcher under the steam lance until the consistency of the milk foam is to their liking. This is a manual process in which the steam lance is immersed in the pitcher filled with an appropriate amount of milk and foamed using a special procedure or method, including suitable movements if necessary, until the required temperature and consistency are achieved.

DE 602 15 058 T2 describes a device for producing a milk-air emulsion, which has at least one steam lance designed to be immersed in a container filled with milk, wherein steam and air can be conducted through the steam lance into the milk with the aid of a steam system (7) and an air system, wherein the steam system and the air system can each be controlled by a control device. The air supply can be switched on and off during the production of the milk-air emulsion. An analogous prior art is disclosed in DE 20 2018 005 263U1 , wherein the air flow rate can be set to a selectable constant value.

Further information on the technological background can be found in DE 10 2017 115 845B4 , DE 10 2018 101 025A1 , WO 20 16/097923A1, DE 10 2011 077 776A1 , and US 2006/0272516A1 .

The invention has the object of simplifying the known methods while retaining the principle of the steam lance immersed in the milk.

The invention solves this object by means of a device having the features of claim 1 and a method having the features of claim 11.

First, a device for producing a milk-air emulsion is created, which has at least one steam lance which is designed to be immersed in a vessel filled with milk, wherein steam and air can be conducted through the steam lance into the milk with the aid of a steam system and with the aid of an air system, wherein the steam system and the air system can each be controlled by a control device on which a milk-air emulsion production program is loaded and can be executed, which has access to a memory on which at least one or more milk-air emulsion production profiles are stored, each in the form of a control profile, so that the steam and the air can be conducted into the milk in accordance with a respectively selected milk-air emulsion production profile in order to automatically produce the milk-air emulsion in the vessel, wherein the one or more milk-air emulsion production profiles comprise at least one control of the air system during at least two time phases in which a varying amount of air is added, which is greater than zero in each case.

In the context of this document, “air addition” is understood to mean “air flow/time.” After step d), during the production of the milk, the air flow/time is thus set to at least two values different from zero at at least two points in time or, preferably, time intervals, for example, in a first time phase to a maximum air flow/time that can be generated, e.g., with a controllable air pump, and during a second time phase to a value corresponding to 50% of the maximum air flow/time that can be generated. These values are to be understood here purely as examples for illustrative purposes. The air flow/time may also be changed during a period of time, for example, this value may be increased or decreased linearly or nonlinearly during a period of time or several periods of time starting from a base value.

By setting the air flow/time to at least two values other than zero during milk production, it is much easier and more precise to achieve the desired foam consistency than if the air addition is constant or if the air addition is only differentiated between “on” (and then constant air addition) and “off” (=no air addition, air addition=0).

The milk-air emulsion production profile in the sense of a control profile, or in particular the starting point and the end of individual time phases or control phases, may depend on one or more physically measurable parameters measured during production.

In particular, it can be designed as a temperature-dependent and/or pressure-dependent and/or time-dependent control profile.

This makes it possible, after filling the vessel, to automatically generate a milk-air emulsion in a simple manner according to a flow chart while maintaining the “steam lance principle.” Production is preferably terminated after reaching a limit value contained in the chart (e.g., a time limit value or a temperature limit value). The at least one chart may, in its simplest form, contain constant steam and air supply quantities over a defined period of time. However, it may also be more complex, as will be explained below with examples.

In the above and below, the terms “milk-air mixture,” “milk-air emulsion,” and “milk foam” are used synonymously. The term “milk” should not be interpreted too narrowly. It includes, in particular, animal milk as well as wholly or partly plant-based milk products (e.g., oat milk and soy milk).

It is expedient for the air system to have at least the following: at least one or more air throttles, at least one controllable air pump connected to the control device, and an air line. Then, according to one variant, it may be particularly useful and advantageous to provide that the at least one air throttle is connected to the control device and that it is designed as a controllable motorized air throttle. According to another advantageous variant, it may also be provided, alternatively or optionally, that the delivery rate of the air pump can be automatically changed and adjusted by the control device. This type of control is simple and reliable. According to another variant, it may be advantageous and structurally simple to design the multiple air throttles as static air throttles, to which one or more air selection valves connected to the control device and controllable by it are assigned. The device-in particular a coffee machine with the device-preferably has a display for outputting information during the program sequence and an input unit-e.g., in the form of a touch display-for entering data, e.g., for preselecting and presetting the type of milk and the like.

It may also be advantageous to provide that the steam system has at least one steam boiler, at least one controllable steam valve, and a steam line.

According to a preferred design, it may be provided that the one or more milk-air emulsion production profiles further comprise at least one time phase in which no air is added. It may also be provided that the one or more milk-air emulsion production profiles comprise at least three time phases in which three different amounts of air are added and/or that the one or more milk-air emulsion production profiles also comprise at least one time phase in which no steam is added and at least one time phase in which steam is added. In this way, a particularly good foam consistency can be achieved in each case.

It is also possible for the air line and the steam line to converge into a common combined steam/air line that is guided through the steam lance which can be immersed in the milk in the vessel.

However, it is also conceivable that the air line and the steam line are guided separately through the steam lance which can be immersed in the milk in the vessel, or that the air line and the steam line are guided separately through the steam lance and an air lance, each of which can be immersed in the milk in the vessel.

It is also advantageous according to an advantageous further development if the memory is a local memory or cloud storage. The “connections” within the scope of this document can then be designed to be wireless or wired if they are designed or can be designed as data connections.

The flow chart can also be changed or completely redesigned, for example manually or adaptively in response to one or more measurement results. This will be explained in more detail below using examples.

The invention also creates a beverage dispenser, in particular a coffee machine, having at least one device according to one of the claims referring thereto.

The invention also provides a method for producing a milk-air emulsion from milk using a device according to one or more of the preceding claims, which comprises at least the following steps:
a) providing the device, providing a vessel and providing milk,
b) filling the vessel with the milk and arranging the vessel in such a way that the steam lance is immersed in the milk; and
c) introducing air and steam through the steam lance into the milk in the vessel, wherein the air system and the steam system are controlled by the control device with the milk-air emulsion production program according to at least one pre-stored milk-air emulsion production profile in order to produce the milk-air emulsion,
d) wherein the control of the air system in step c) comprises at least two time phases in which different amounts of air greater than zero are added.

Since, after step d), the air flow/time is thus set to at least two values different from zero during the production of the milk, a desired foam consistency can be achieved in a targeted manner. For further optimization, according to a preferred variant, it may also be provided that the control of the air system in step c) further comprises at least one time phase in which no air is added. And for further optimization, it may also be provided that the control of the steam system in step c) further comprises at least one time phase in which no steam is added and a further time phase in which steam is added in order to further optimize the foam consistency.

It is conceivable that the vessel is filled with milk manually or, particularly simply, automatically by means of a milk lance.

It is then conceivable and advantageous if the milk-air emulsion production profile is adapted to one or more operating parameters during the production of the milk foam. For this purpose, at least one or more operating parameters can be determined once or several times during the process, which are used to adapt the milk-air emulsion production profile.

It is useful and advantageous if the operating parameter or parameters determined once or several times during the process and used to adjust the milk-air emulsion production profile comprise the temperature of the milk in the vessel. It is also particularly advantageous if the amount of milk to be frothed in the vessel is entered into the system.

Particularly good results in terms of optimal milk foam can be achieved by varying the amount of air introduced into the milk or the milk-air emulsion being formed over time during the production of the milk-air emulsion.

It is also conceivable that during the production of the milk-air emulsion, the amount of steam introduced into the milk-air emulsion is kept constant over time or varied over time.

It is advantageous if, after starting the milk-air emulsion production program, the amount of milk and/or the type of milk and/or the desired consistency of the milk-air emulsion can be preselected via data input. It is also advantageous if, after starting the milk-air emulsion production program, this program suggests presettings for the air addition duration (foam volume) and/or the air addition quantity (bubble size) and/or the target temperature and/or if these can be individually adjusted by the user.

It is particularly simple and advantageous if the foam quantity can be adjusted by adjusting the duration of the air addition or the air flow/time. This is because the properties of the air-milk emulsion can be influenced particularly well by varying the air addition. It is then particularly advantageous if the milk temperature in the vessel is determined during the production of the milk-air emulsion and if this measured value is included in the process control.

According to the invention, a wide variety of control and sequence profiles can be generated and used. According to a particularly advantageous milk-air emulsion production profile, the control of the air system comprises at least three time phases, wherein in a first phase no air is added up to a temperature value “1”, then, in a second phase, a small amount of air is added up to a temperature value “2,” then, in a third phase, a large amount of air is added up to a temperature value “3,” and then, preferably, in a fourth phase, a very small amount of air is added from a temperature value “4” onwards.

Within the scope of the present invention, the method and/or device according to the invention can be used in an apparatus for dispensing, and in particular also for preparing, a beverage. A corresponding apparatus is preferably designed as a fully automatic coffee machine.

Further advantageous embodiments are mentioned in the dependent claims.

The invention will now be described in more detail with reference to the drawings and exemplary embodiments. It should be emphasized that these exemplary embodiments are not to be understood as limiting. The invention is implemented particularly advantageously in this exemplary embodiment. The individual features of these exemplary embodiments can be advantageously used in combination with the respective other features of the exemplary embodiments. However, they can also be combined with other exemplary embodiments shown or not shown and are also suitable as advantageous designs of the objects described in one or more of the main and subclaims, wherein:

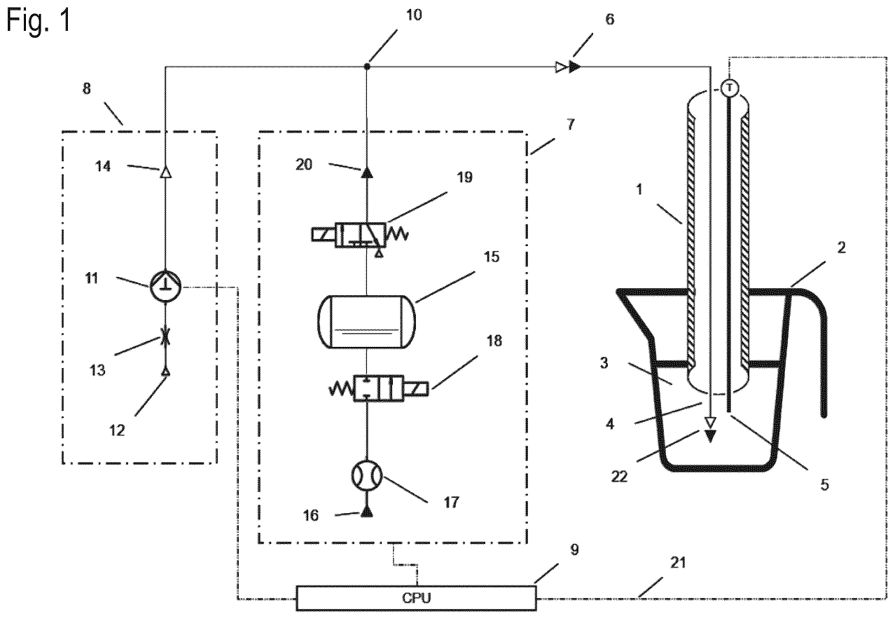

FIG. 1 shows a schematic representation of the structure of a first device according to the invention for producing milk-air emulsions, in particular milk foam;

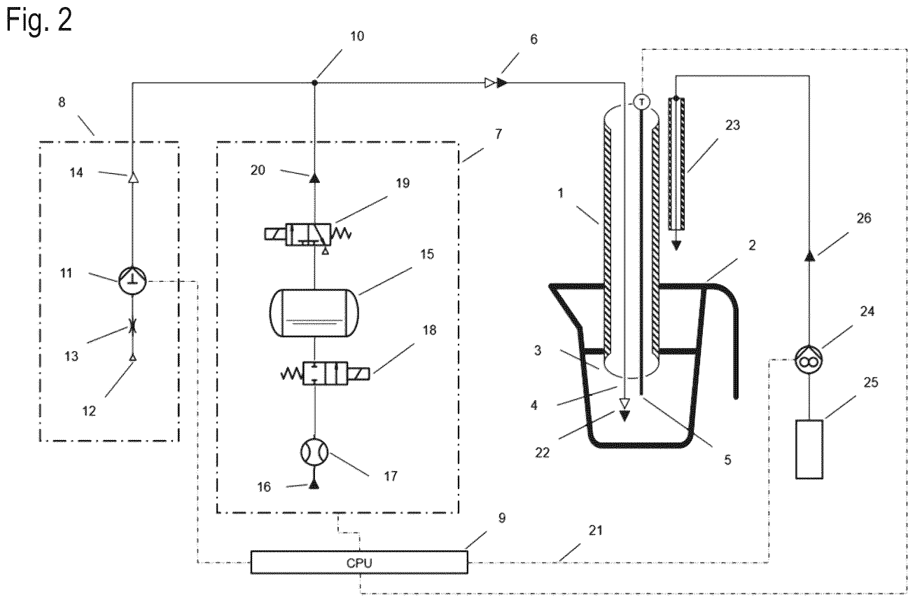

FIG. 2 shows a schematic representation of the structure of a second device according to the invention for producing milk-air emulsions, in particular milk foam;

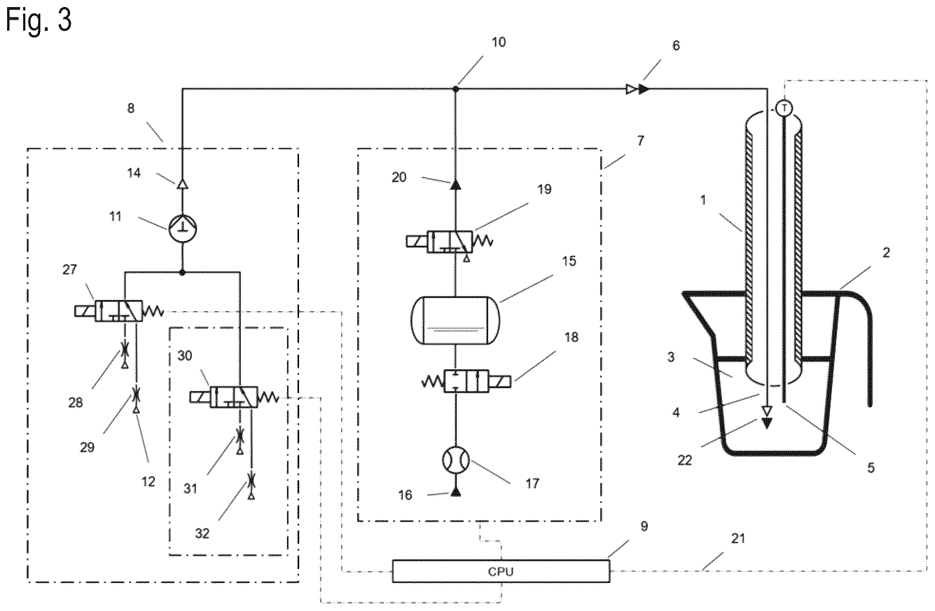

FIG. 3 shows a schematic representation of the structure of a third device according to the invention for producing milk-air emulsions, in particular milk foam;

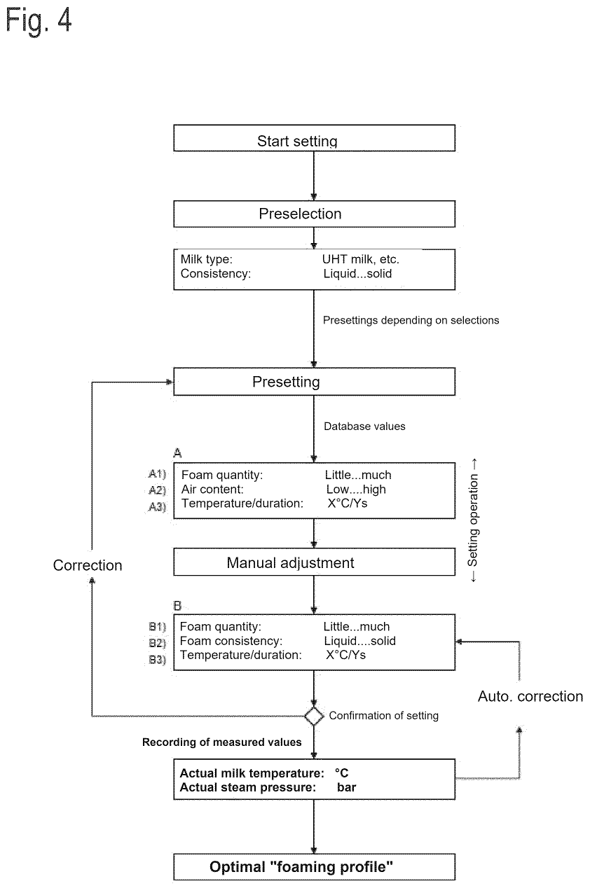

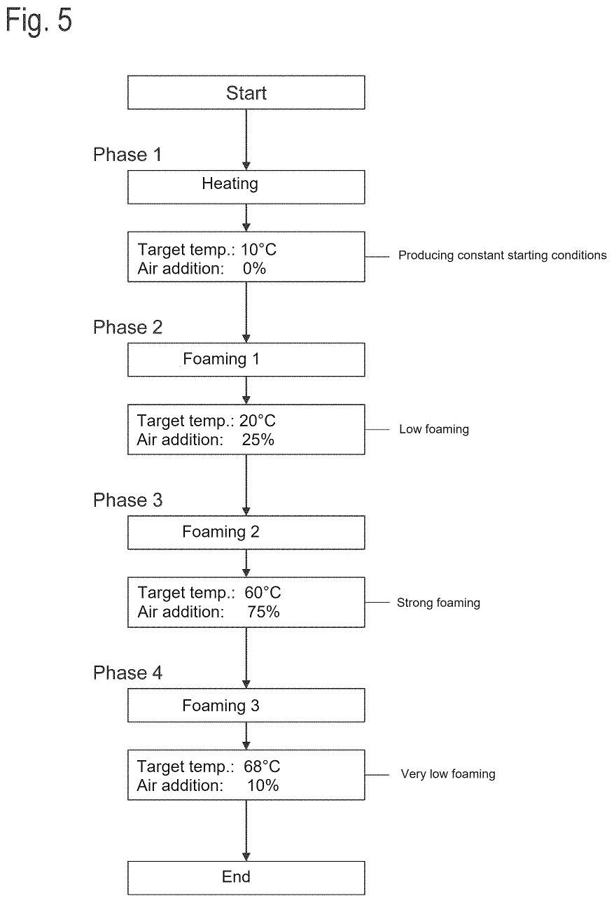

FIGS. 4, 5 show flowcharts illustrating exemplary methods for producing a milk-air emulsion;

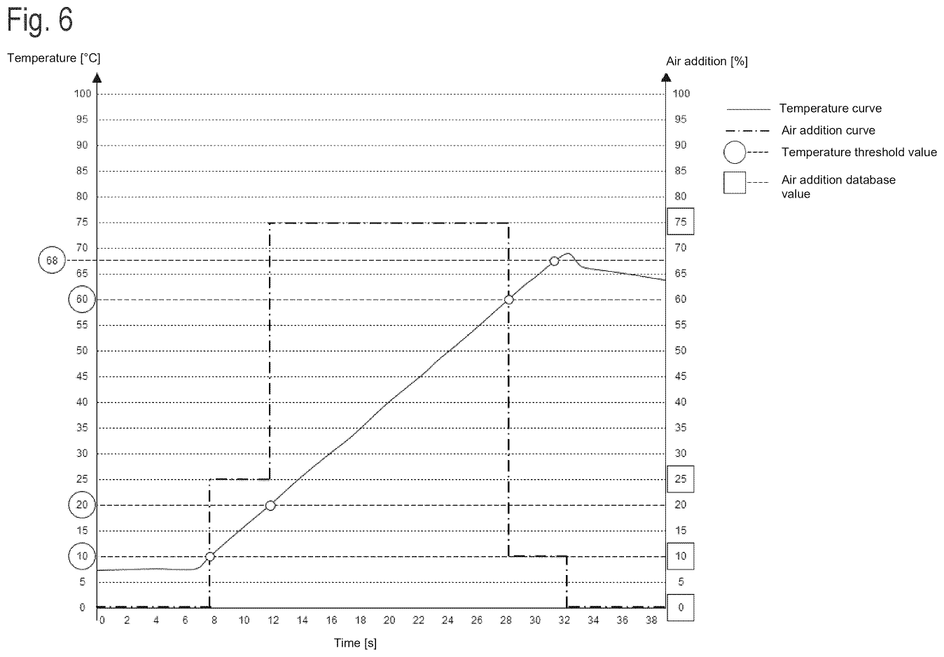

FIG. 6 shows a diagram for visualizing the influence of various parameters on the quality of a milk-air emulsion.

Various exemplary embodiments are described in the following figure description. The individual features of these exemplary embodiments can be advantageously used in combination with the respective other features of the exemplary embodiments. However, they can also be combined with other exemplary embodiments shown or not shown and are also suitable as advantageous designs of the objects described in one or more of the main and subclaims.

FIG. 1 shows a first exemplary structure of a device according to the invention for the preferably automated production of milk-air emulsions. The device can form an integral part of a beverage dispenser, in particular a coffee machine. This coffee machine can be designed in a variety of ways. However, it can also form a separate unit which, for example, is placed next to a beverage dispenser as a stand-alone device. This is because the device for producing milk foam—whether integrated into the beverage dispenser or designed separately—is essentially designed separately from the section of the coffee machine that is used to produce the coffee.

The devices shown in FIGS. 1 to 3 for producing milk-air emulsions are used to produce, from a medium such as milk 3, which is preferably “untreated” or poured from the package or a tank into a vessel 2, by means of at least one steam lance 1, which is immersed in the vessel 2, with the aid of air and steam, which are fed into the milk through the steam lance 1, with the aid of automated control of the addition of air and steam to the milk, to produce a milk-air emulsion, in particular in the form of milk foam. The term “milk” should not be interpreted too narrowly. It includes animal milk types as well as non-animal plant-based milk substitutes such as soy milk, oat milk, or similar products.

This milk foam can then be used to prepare a coffee specialty. For example, the milk foam can be poured into a cup that has been partially filled with coffee or that is to be filled with coffee afterwards to prepare a cappuccino or similar beverage.

The steam lance 1 can have an elongated shape, which allows it to be immersed from above into a vessel 2 such as a cup or pitcher. It can have an outer jacket in the form of a pipe. This outer jacket can be made of metal or another material such as ceramic. A combined steam/air line 4 is routed through the steam lance 1. A thermometer 5 may also be formed in or on the steam lance. This may be connected to a control device 9 (which may be designed as a CPU) via a data link such as a cable or wirelessly. It is arranged in such a way that it is usually immersed with the free end of the steam lance 1 into the medium, such as milk, located in the vessel 2.

It may also be provided alternatively that a further separate supply line is formed in the steam lance, through which air can be fed into the vessel 2. In this case, only steam is supplied through the line 4 and air is supplied through the further line (not shown here).

The milk can be poured into the vessel 2—in this case, the pitcher—from a separate container or, preferably, from a tank 25 and an outlet of the beverage dispenser, as shown in the exemplary embodiment in FIG. 1. Such an exemplary embodiment is shown in FIG. 2. Here, at least one milk pump 24 can be used to automatically feed the milk from the tank 25 through a milk line 26, preferably before the heating and/or frothing process, through a dispensing lance 23 (milk wand) as an outlet, which is preferably positioned directly next to the steam lance 1 above the pitcher 2 of the otherwise unillustrated beverage dispenser. It is very advantageous that the steam lance 1 and the milk dispensing nozzle 23 are clearly separated in terms of construction.

If several types of milk are to be used, it is also possible to provide several such milk wand systems (not shown). This has the advantage of complete medium separation.

Thus, in a method according to the invention, after a device for producing a milk-air emulsion, preferably milk foam (or a beverage dispenser with such a device), has been provided, the milk is first poured into the vessel 2.

This can be done manually. Or it can be done automatically by means of a dispensing nozzle, from which milk is fed from the tank 25 into the vessel. For this purpose, the milk pump can be controlled by a control device 9 in order to switch it on and off and/or to vary the speed of the milk pump 24.

In step B), air can be fed into the steam/air line 4 together with steam or separately using an air system 8 via an air line 14 and a steam system 7 via a steam line 20 through the steam/air line 4 and through the steam lance 1 into the vessel 2.

The air and steam can be fed into the steam/air line 4 in a controlled or regulated manner. According to an initial design, the air and steam can be added according to a pre-stored time sequence.

Alternatively, the flow chart can be changed or created from scratch, for example manually or adaptively in response to one or more measurement results. This will be explained in more detail below using examples. The air and steam can, for example, be fed into the steam/air pipe 4 individually with a time delay or simultaneously. For this purpose, the steam system 7 and the air system 8 are each connected to the control device 9 (CPU). This may have a CPU and memory or be connected to such a device—locally or via, for example, a network or cloud connection—and may be equipped with a control and/or regulation program with which the steam/air supply through the steam/air supply line 4 into the vessel 2 can be controlled or regulated.

It is possible to use the control and/or regulation program to control the sequence of the method for the automated production of a milk-air emulsion. This will also be described in more detail below with the aid of examples.

The air system 8 can be designed or constructed in various ways. Examples of designs are shown in FIGS. 1 and 3. However, the invention is not limited to these. The air system 8 could also be constructed in other ways.

According to FIG. 1, the air system 8 has, in an advantageous design, an air inlet for air from an “air source 12,” which can be formed from a tank or, for example, from the ambient air. At least one throttle, in particular a motorized air throttle 13, and an air pump 11 may be connected downstream of this air source 12 in the air line 14, thereby providing means by which the air from the air source 12 can be conveyed through the air line 14 into the steam/air line 4.

Preferably, the amount of steam and/or air fed into the steam/air line 4 can be varied by means of corresponding control by the control device 9. By definition, the “amount of air” (“air flow/time”) is also referred to here as “air addition”. For this purpose, the motorized air throttle 13 and/or the air pump 11 can be controllable and connected to the control device 9 at least via a control line (a wired line or wireless design). There are at least two phases in which the air flow/time or the air addition is or can be set to different values greater than zero.

According to FIG. 3, no controllable air throttle 13 is provided. However, the amount of air fed into the steam/air line 4 can still be changed. This is achieved by means of several throttles—in this case four—air throttles 28, 29, and 31, 32 (a1, a2, b1, b2) with preferably different cross-sections, which can be used either individually or, optionally, together for the air supply. For this purpose, the air system 8 in FIG. 3 has several—in this case, four—connections to several or to a common air source 12, which in turn can be formed, for example, from a tank or from the ambient air.

One or more air sources 12 can each have an air throttle 28, 29 or 30, 31 connected to branch lines, and these air throttles 28, 29 or 30, 31 can in turn have one or more air selection valves 27, 30 connected downstream, which in turn can have an air pump 11 connected downstream.

Controlled switching of the two air selection valves 27, 30 allows switching between the air throttles 28, 29 and 31, 32. Branch lines from the air selection valves 27, 30 converge in the air line 14. The air pump 11 may in turn be connected downstream of the air line 14.

The air selection valves 27, 30 and/or the air pump 11 can be controllable and connected to the control device 9.

By means of suitable control, the air path through one of the air throttles 28, 29 or 30, 31 is opened and the others are preferably closed. In this way, an air path from the air source 12 through one of the air throttles 28, 29 or 31, 32 to the steam/air line is opened.

It is also conceivable that the air path is opened by two or more of the air throttles. In this case, several air throttles with the same cross-section can also be used, for example.

It is also conceivable that the at least one controllable air pump is designed in such a way that its delivery rate can be varied during operation of the air pump, for example, it can be variably adjusted with the aid of the control device.

The steam system 7 can also be designed in various ways. Its task is to generate steam from water and feed it into the steam lance 1, optionally via an intermediate line such as the steam/air line 4. A particularly preferred variant is shown in FIGS. 1 to 3.

The steam system 7 can be connected to a water source 16, which can be formed, for example, by a water pump or another water supply.

Downstream of this water source 16, a flow meter 17, a controllable filling valve 18, a steam boiler 15, and a steam line 20 with a steam trap and vent valve 19 may preferably be provided. The steam line 20 may open into the steam/air pipe 4.

However, the steam system 7 may also be constructed in other ways. For example, according to an alternative design not shown here, the steam pressure in the steam line may be adjustable or controllable directly or by means of a motorized throttle in the steam channel 20 (it may be provided that corresponding profiles for air and steam are stored).

The steam system 7 and the air system 8 are preferably each controllable by the control device 9, on which a milk-air emulsion production program is loaded and executable, wherein the control device has access to a memory on which at least one or more milk-air emulsion production profiles are stored, so that the steam and air can be fed into the milk in accordance with a respectively selected milk-air emulsion production profile in order to automatically produce the milk-air emulsion in the vessel 2.

The device 1 can, for example, be advantageously used as follows to produce a milk-air emulsion.

The medium 3 to be heated and/or frothed, preferably milk or a milk substitute product, is added manually or automatically to the vessel 2—e.g., the pitcher—and positioned under the steam lance 1, wherein the steam lance 1 and, in particular, the nozzle with the steam outlet openings 22 should be immersed in the medium.

The steam generated in the steam system 8 in a steam boiler 15 is fed into the milk 3 through the lance via pipes located in the coffee machine when triggered with a preset steam product. The steam generator and the necessary valve position are controlled by a computing unit, also known as a control device 9, which preferably records the duration/process time of milk froth generation and/or the medium temperature measurement with the temperature sensor 5 in parallel.

The temperature is measured, for example, by means of a sensor/probe 5, which has a tube that runs through the steam lance 1 and a measuring tip that can be located outside the steam lance parallel to the steam-air mixture outlet 4. The measurement is advantageously carried out directly in the medium 3.

The addition of steam and/or air can then be controlled depending on parameters, for example depending on preset time and/or temperature values, which can be carried out via the control device 9.

The air is preferably added by means of the air pump 11, which is activated as required by the computing unit or the control device 9 and supplies a defined amount of air to the steam flow according to the selected process sequence, also known as the control profile or milk-air emulsion production profile. The steam-air mixture 6 is fed through a steam/air line 4 or several internal pipes in the steam lance 1 to the steam outlet opening(s) in the manner of a steam nozzle 22 and foams the medium 3 in the vessel—in particular in a pitcher—2 during and after the outlet.

It is possible to set individual switch-off temperatures for the air and steam addition, which are preferably between 50° C. and 70° C.

It is also possible to set individual process times for the air and steam addition, which are based on the respective milk quantity, for example, 30 seconds of steam addition parallel to 20 seconds of air addition for 180 ml of milk.

Instead of a fixed/static air volume addition, it is alternatively also possible to vary the air volume before and during foam preparation. Dynamic adjustment of the air volume allows the machine to respond to individual requirements, fluctuating environmental conditions, and special circumstances in order to achieve ideal foam results regardless of these factors.

Air addition control is preferably performed as a function of temperature and/or time (and/or other measurable physical variables) and can also be adjusted to the type of milk, milk temperature, target consistency, target foam volume, and target temperature.

Preset milk-air emulsion production profiles can be used for dynamic air addition control in particular to achieve optimum milk processing through time-varying air addition.

For example, by adjusting valve 13, different opening cross-sections can be generated, through which the amount of air generated by air pump 11 and supplied to the steam can be varied. A large opening cross-section corresponds to a large amount of air, while a small opening cross-section corresponds to a small amount of air. The setting can be controlled and/or regulated in advance of foam preparation and/or during preparation. It is also conceivable to regulate or control and/or regulate the air delivery rate of the air pump by adjusting the speed accordingly.

With dynamic air addition control, preset profiles can be used for optimal milk processing. The profiles can be stored in the data memory of the control device 9 and can differ depending on the type of milk available (preselection) and/or the desired milk foam target properties.

The milk foam produced in this way can then be used to make a specialty beverage.

FIG. 4 illustrates by way of example how suitable milk-air emulsion production profiles or control diagrams can be determined.

When or after starting the program for producing the milk-air emulsion, the type of milk is preselected or the type of milk to be processed (e.g., UHT milk 3.8%) and the consistency to be produced (e.g., still rather liquid foam, rather firm foam) (very liquid (flowable) to very firm (dry) foam).

Suitable and likely appropriate presets for the air addition duration (foam quantity), air content (bubble size), and target temperature/duration can then be suggested, for example, based on the manufacturer's database values. These can be further optimized or individually adjusted to customer requirements by the user/technician on site or via remote maintenance.

The milk temperature and steam pressure are internal machine measurement data and are included as initial conditions in the presetting by the control device in its process control.

The following are examples:

Adjustment of the foam quantity by setting the duration of the air addition (pump running time).

Adjustment of the foam consistency by adjusting the amount of air added (opening cross-section).

Adjustment of the target temperature by defining the switch-off temperature for steam addition.

Depending on the result (does the milk foam meet expectations in terms of quantity, consistency, and/or temperature), product-specific settings and corrections can then be made as an option. Preferably, several different settings can be stored and retrieved.

In this way, optimal milk-air emulsion production profiles can be determined, stored, and then used for process control depending on the type of milk and the desired foam consistency. This determination and storage of additional milk-air emulsion production profiles can be performed by a user or by designing the program as a self-learning system.

When controlling based on temperature, the milk temperature can also be measured in real time by the temperature sensor 5 (measuring probe) in the lance, and the measurement results can be used to adjust the air supply. This can be done during operation. It is advantageous if milk temperature ranges with defined air addition quantities are pre-stored in the memory of the control device 9. Air addition profiles depending on the type of milk can also be stored (database values), a start air addition depending on the milk temperature, and an air addition in several phases, in particular depending on the measured milk/milk foam temperature.

Such an example will be explained in more detail below with reference to FIGS. 5 and 6.
Phase 1—No air addition until target temperature phase 1—for example, 10° C.; heating to a defined initial condition without air addition in order to achieve repeatable foaming results regardless of the initial milk temperature.
Phase 2—Low air addition (air flow/time relative to the maximum possible air flow/time) until target temperature Phase 2—for example, 20° C.; foaming with low air addition (25%) to initialize the frothing process until ideal air intake conditions are reached; preventing the coalescence of small air bubbles (too large air bubbles) which rise to the surface.
Phase 3—High air addition until target temperature phase 3—for example 60° C.; foaming with high air addition 75% during the ideal range (between 20° C. and 60° milk/milk foam temperature) to achieve a high volume increase.
Phase 4—Very low air addition from target temperature phase 4—for example, 68° C.; foaming with very low air addition 10% to prevent deterioration of the foam result due to expansion of the air bubbles at high temperatures.

### LIST OF REFERENCE SIGNS

1. Steam lance
2. Vessel (preferably a pitcher)
3. Medium (preferably milk or milk substitute)
4. Steam/air line
5. Temperature sensor
6. Steam-air mixture
7. Steam system
8. Air system
9. Computing unit
10. Steam/air mixing connector (steam jet nozzle)
11. Air pump
12. Air source
13. Air throttle
14. Air/air line
15. Steam boiler
16. Water supply/water pump
17. Flow meter
18. Filling valve
19. Vapor barrier and ventilation valve
20. Steam/steam line
21 Data line
22. Steam nozzle
23. Milk lance/foam wand
24. Milk pump
25. Milk tank
26. Milk/milk line
27. Air selection valve
28. Air throttle
29. Air throttle
30. Air selection valve
31 Air throttle
32. Air throttle

1: A device for producing a milk-air emulsion, comprising:
at least one steam lance (1) which is designed to be immersed in a vessel (2) filled with milk,
a steam system (7) and an air system (8), which are configured for conducting steam and air, respectively, into the milk, wherein the steam system (7) and the air system (8) are each controllable by a control device (9) on which a milk-air emulsion production program is loaded and can be executed, wherein the milk-air emulsion production system has access to a memory on which at least one or more milk-air emulsion production profiles are stored, so that the steam and the air can be conducted into the milk in accordance with a respectively selected milk-air emulsion production profile in order to automatically produce the milk-air emulsion in the vessel (2), wherein the one or more of the milk-air emulsion production profiles comprise at least one control of the air system (8) during at least two time phases in which a varying amount of air is added, which is greater than zero in each case.

2: The device according to claim 1, wherein the air system comprises at least the following:
a. at least one or more air throttles (13, 28, 29, 31, 32),
b. at least one controllable air pump (11) connected to the control device, and
c. an air line (14).

3: The device according to claim 2, wherein the at least one air throttle is connected to the control device (9) and is designed as a controllable motorized air throttle (13).

4: The device according to claim 2, wherein the at least one controllable air pump is designed such that a delivery rate is variable.

5: The device according to claim 1, wherein the one or more milk-air emulsion production profiles further comprise at least one of the following:
a) at least one time phase in which no air is added,
b) at least three time phases, in each of which three different amounts of air are added, or
c) at least one time phase in which no steam is added and at least one time phase in which steam is added.

6-7. (canceled)

8: The device according to claim 2, wherein the plurality of air throttles are designed as static air throttles (28, 29, 31, 32), to which one or more air selection valves (27, 30) connected to the control device (9) and controllable thereby are assigned.

9: The device according to claim 1, wherein the steam system has at least one steam boiler (15), at least one controllable steam valve (19), and a steam line (20).

10. (canceled)

11: The device according to claim 1,
wherein the air line (14) and the steam line (20) open into a common combined steam/air line (4) which is guided through the steam lance (4), or the air line (14) and the steam line (20) are guided separately though the steam lance, and
wherein the steam lance is configured to be immersed in the milk in the vessel.

12. (canceled)

13: A beverage dispenser, in particular coffee machine, having at least one device according to claim 1.

14: A method for producing a milk-air emulsion from milk using a device according to claim 1, comprising at least the following steps:
d. providing the device, providing a vessel (2) and providing milk,
e. filling the vessel (2) with the milk and arranging the vessel (2) in such a way that the steam lance (1) is immersed in the milk; and
f. introducing air and steam through the steam lance (1) into the milk in the vessel (2), wherein the air system (8) and the steam system (7) are controlled by the control device with the milk-air emulsion production program according to at least one pre-stored milk-air emulsion production profile in order to produce the milk-air emulsion,
g. wherein the control of the air system (8) in step c) comprises at least two time phases in which different amounts of air are added, each of which is greater than zero.

15: The method according to claim 14, wherein the control of the air system (8) in step f) further comprises at least one of the following:
at least one time phase in which no air is added,
three time phases, in each of which three different amounts of air are added, or
at least one time phase in which no steam is added.

16-17. (canceled)

18: The method according to claim 14, wherein the vessel (2) is filled with milk manually or automatically.

19: The method according to claim 14, wherein during operation of the method, at least one or more operating parameters are determined once or several times, which are used to adjust the milk-air emulsion production profile during the operation of the method.

20: The method according to claim 14, wherein the operating parameter or parameters determined once or several times during operation of the method, which are used to adjust the milk-air emulsion production profile, comprise a temperature of the milk in the vessel (2).

21. (canceled)

22: The method according to claim 14, wherein during the production of the milk-air emulsion, an amount of air or steam introduced into the milk is kept constant or varied over time and/or temperature.

23: The method according to claim 14, wherein, after starting the milk-air emulsion production program, a preselection of milk quantity and/or milk type and/or consistency of the milk-air emulsion to be produced is made via data input, wherein after starting the milk-air emulsion production program, the air-emulsion program suggests presettings for air addition duration and/or air addition quantity and/or target temperature.

24-25. (canceled)

26: The method according to claim 14, wherein foam quantity is adjusted by adjusting a duration of air addition.

27. (canceled)

28: The method according to claim 24, wherein the target temperature is adjusted by defining a switch-off temperature for steam addition.

29: The method according to claim 14, wherein during the production of the milk-air emulsion, a milk temperature in the vessel (2) is measured and the measured temperature is included in the control.

30: The method according to claim 14, wherein during the production of the milk-air emulsion, a further milk-air emulsion production profile is determined and stored as a function of the type of milk and/or the desired foam consistency and is used to control a sequence of the milk-air emulsion production.

31: The method according to claim 14, wherein during the production of the milk-air emulsion, the control of the air system (8) comprises three or more phases, wherein in a first phase, no air is added up to a temperature value “1”, then, in a second phase, a small amount of air is added up to a temperature value “2,” then, in a third phase, a large amount of air is added up to a temperature value “3,” and then, in a fourth phase, a very small amount of air is added from a temperature value “4” onwards.
